(19) United States
(12) Patent Application Publication
(10) Pub. No.: US 2012/0320647 A1
(43) Pub. Date: Dec. 20, 2012

(54) SWITCHING BRANCH FOR THREE-LEVEL RECTIFIER, AND THREE-PHASE THREE-LEVEL RECTIFIER

(75) Inventor: Tero VIITANEN, Vantaa (FI)

(73) Assignee: ABB OY, Helsinki (FI)

(21) Appl. No.: 13/523,066

(22) Filed: Jun. 14, 2012

(30) Foreign Application Priority Data
Jun. 15, 2011 (FI) 20115600

(51) Int. Cl. H02M 7/155; H02M 7/06

(52) U.S. Cl. 363/126

(57) ABSTRACT

An exemplary switching branch for a three-level rectifier includes a first diode and a first semiconductor switch connected in series between a positive direct voltage pole and a neutral direct voltage pole, a second diode and a second semiconductor switch connected in series between a negative direct voltage pole and the neutral direct voltage pole as well as a thyristor and a third diode connected in series between a connection point between the first diode and the first semiconductor switch and a connection point between the second diode and the second semiconductor switch in such a manner that a connection point between the thyristor and the third diode is connected to an alternating voltage pole of the switching branch.

### RELATED APPLICATION

This application claims priority under 35 U.S.C. §119 to Finnish Application No. 20115600 filed in Finland on Jun. 15, 2011. The content of which is hereby incorporated by reference in its entirety.

### FIELD

The disclosure relates to a rectifier, such as a switching branch for a three-level rectifier, and to a three-phase, three-level rectifier.

### BACKGROUND INFORMATION

Three-level rectifiers are rectifiers having three direct voltage poles. They not only have a positive and negative direct voltage pole, but also a neutral direct voltage pole. Examples of three-level rectifiers are disclosed in publications Y. Zhao, Y. Li and T. A. Lipo, “Force commutated three level boost type rectifier”, IEEE transactions on industry applications, Vol. 31, No. 1, January/February 1995, and J. W. Kolar and F. C. Zach, “A novel three-phase utility interface minimizing line current harmonics of high-power telecommunications rectifier modules”, IEEE transactions on industrial electronics, Vol. 44, No. 4, August 1997.

FIG. 1 shows a circuit diagram of the main circuit of a three-phase three-level rectifier in accordance with a prior art implementation. The described rectifier includes (e.g., comprises) three switching branches, each of which has one alternating voltage input pole AC1, AC2, AC3. The direct voltage output, in turn, consists of three poles: a positive direct voltage pole Udc+, negative direct voltage pole Udc−, and neutral direct voltage pole NP. A direct voltage intermediate circuit of the rectifier, in turn, includes capacitors C1 and C2 connected in series between the positive direct voltage pole Udc+ and the negative direct voltage pole Udc− in such a manner that the neutral direct voltage pole NP is formed at the connecting point of the capacitors. Each switching branch of the rectifier further includes four diodes connected in series between the positive and negative direct voltage poles and two controllable switches that modulate the input voltage according to a given modulation method. Possible modulation methods include e.g. vector modulation and hysteresis modulation. The upper switch in each switching branch then commutates with the topmost diode connected in series, and the lower switch commutates with the lowest diode connected in series in accordance with the modulation plan. In the example of the figure, a diode is also connected in parallel to each controlled switch.

The capacitors in the direct voltage intermediate circuit of the rectifier can be charged before normal use of the rectifier. Charging of the capacitors may be performed, for instance, by means of a contactor and a charging resistor in such a manner that in the charging stage the capacitor charging current is connected by means of the contactor to circulate via the charging resistor, which limits the charging current. A problem with this solution is, for instance, that it is a separate contactor.

### SUMMARY

An exemplary switching branch for a three-level rectifier is disclosed, comprising: a first diode and a first semiconductor switch connected in series between a positive direct voltage pole and a neutral direct voltage pole, wherein the first diode and the first semiconductor switch reside in a first switching branch-specific semiconductor module; a second diode and a second semiconductor switch connected in series between a negative direct voltage pole and a neutral direct voltage pole, wherein the second diode and the second semiconductor switch reside in a second switching branch-specific semiconductor module; and a thyristor and a third diode connected in series between a connection point between the first diode and the first semiconductor switch and a connection point between the second diode and the second semiconductor switch, wherein a connection point between the thyristor and the third diode is connected to an alternating voltage pole of the switching branch.

An exemplary method of charging an intermediate circuit in a rectifier is disclosed, the rectifier including a first diode and a first semiconductor switch connected in series between a positive direct voltage pole and a neutral direct voltage pole, wherein the first diode and the first semiconductor switch reside in a first switching branch-specific semiconductor module; a second diode and a second semiconductor switch connected in series between a negative direct voltage pole and a neutral direct voltage pole, wherein the second diode and the second semiconductor switch reside in a second switching branch-specific semiconductor module; and a thyristor and a third diode connected in series between a connection point between the first diode and the first semiconductor switch and a connection point between the second diode and the second semiconductor switch, wherein a connection point between the thyristor and the third diode is connected to an alternating voltage pole of the switching branch, the method comprising: detecting a voltage of the rectifier; detecting a supply voltage of the rectifier; adjusting a control angle of the thyristor in response to the voltage of the rectifier and the supply voltage of the rectifier.

An exemplary computer readable medium for an electric drive is disclosed, the electric drive having a processor, memory, a first diode and a first semiconductor switch connected in series between a positive direct voltage pole and a neutral direct voltage pole, wherein the first diode and the first semiconductor switch reside in a first switching branch-specific semiconductor module; a second diode and a second semiconductor switch connected in series between a negative direct voltage pole and a neutral direct voltage pole, wherein the second diode and the second semiconductor switch reside in a second switching branch-specific semiconductor module; and a thyristor and a third diode connected in series between a connection point between the first diode and the first semiconductor switch and a connection point between the second diode and the second semiconductor switch, wherein a connection point between the thyristor and the third diode is connected to an alternating voltage pole of the switching branch, the computer readable medium having computer program product recorded thereon which when the computer readable medium is placed in communicable contact with the electric drive, the electric drive executes a method comprising the steps of: detecting a voltage of the rectifier; detecting a supply voltage of the rectifier; and adjusting a control angle of the thyristor in response to the voltage of the rectifier and the supply voltage of the rectifier.

### BRIEF DESCRIPTION OF THE DRAWINGS

The disclosure will be described in greater detail in connection with some embodiments, with reference to the accompanying drawings, in which:

FIG. 1 shows a circuit diagram of a main circuit of a three-phase rectifier according to a prior art implementation;

FIG. 2 shows a circuit diagram of a first switching branch for a rectifier according to an exemplary embodiment of the present disclosure;

FIG. 3 shows a circuit diagram of a second switching branch for a rectifier according to an exemplary embodiment of the present disclosure;

FIG. 4 shows a circuit diagram of a third switching branch for a rectifier according to an exemplary embodiment of the present disclosure;

FIG. 5 shows a circuit diagram of a fourth switching branch for a rectifier according to an exemplary embodiment of the present disclosure; and

FIG. 6 shows a circuit diagram of the main circuit of a three-phase rectifier according to an exemplary embodiment of the present disclosure.

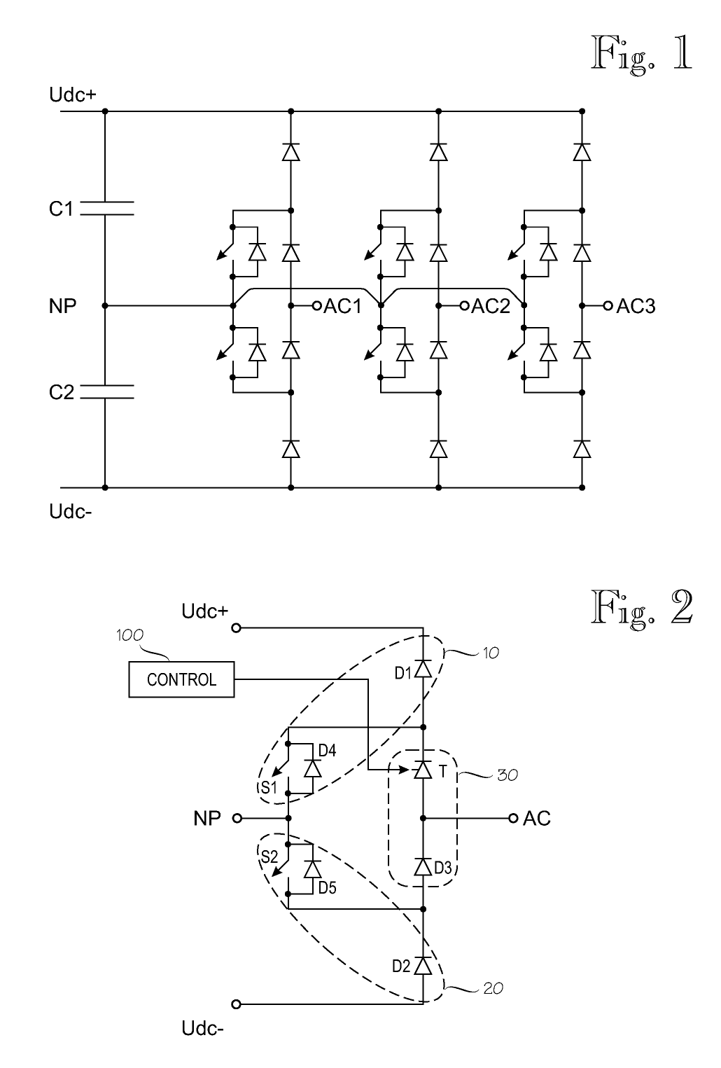

### DETAILED DESCRIPTION

Exemplary embodiments of the present disclosure are directed to a switching branch for a three-level converter a diode connected between a second semiconductor switch and an alternating voltage pole that is replaced by a thyristor. Moreover, the semiconductors are positioned in semiconductor modules in a manner that minimizes stray inductance of a commutation circuit.

Exemplary embodiments described herein provide that the charging of the capacitors in the direct voltage intermediate circuit of the rectifier does not call for a contactor but the capacitors in the intermediate circuit can be charged, for instance, by changing a control angle of the thyristor or via a resistor-diode branch in parallel with the thyristor. In addition, in a fault situation, removal of the thyristor control signal breaks the fault current substantially immediately when the direction of the current tends to change, which enhances the protection of the rectifier equipment. Also, the stray inductance of the commutation circuit can be minimized.

Exemplary embodiments disclosed herein are not restricted to any specific system, but it may be applied to various electric systems. In addition, the use of the disclosure is not restricted to any system utilizing a specific basic frequency or to any specific voltage level.

FIG. 2 shows a circuit diagram of a first switching branch for a rectifier according to an exemplary embodiment of the present disclosure. FIG. 2 shows a circuit diagram of a switching branch for a three-level rectifier in accordance with an embodiment. It should be noted that the figure only presents elements relevant to the understanding of the disclosure. The switching branch may be one switching branch of a three-phase rectifier or a switching branch of a one-phase rectifier. The switching branch of FIG. 2 can include an alternating voltage input pole AC for connecting the switching branch to an alternating voltage output (not shown), and a positive direct voltage pole Udc+, negative direct voltage pole Udc− and neutral direct voltage pole NP. The switching branch can include a first diode D1 and a first controllable semiconductor switch S1, which is connected in series between the positive direct voltage pole Udc+ and the neutral direct voltage pole NP. The switching branch can also include a second diode D2 and a second controllable semiconductor switch S2, which is connected in series between the negative direct voltage pole Udc− and the neutral direct voltage pole NP. The semiconductor switches S1, S2 may be transistors, such as IGBT (insulated Gate Bipolar Transistor) or FET (Field-Effect Transistor), or other semiconductor switches. The control components and couplings of the semiconductor switches S1, S2 are not shown in the figure for the sake of clarity.

Further, the switching branch can include a thyristor T and a third diode D3 connected in series between a connection point between the first diode D1 and the first semiconductor switch S1 and a connection point of the second diode D2 and the second semiconductor S2 in such a manner that the connection point between the thyristor T and the third diode D3 is connected to the alternating voltage pole AC of the switching branch. In the exemplary embodiment of FIG. 2, the thyristor T is connected between the connection point between the first diode D1 and the first semiconductor switch S1 and the alternating voltage pole AC of the switching branch, and the third diode D3 is connected between the connection point between the second diode D2 and the second semiconductor switch S2 and the alternating voltage pole AC of the switching branch. The switching branch may further include a fourth diode D4, which is connected in parallel with the first semiconductor switch S1, and a fifth diode D5, which is connected in parallel with the second semiconductor switch S2, as shown in the Figure. The switching branch may also include a control unit 100 or corresponding control means for controlling the thyristor T through appropriate control signals that are transmitted to a thyristor gate.

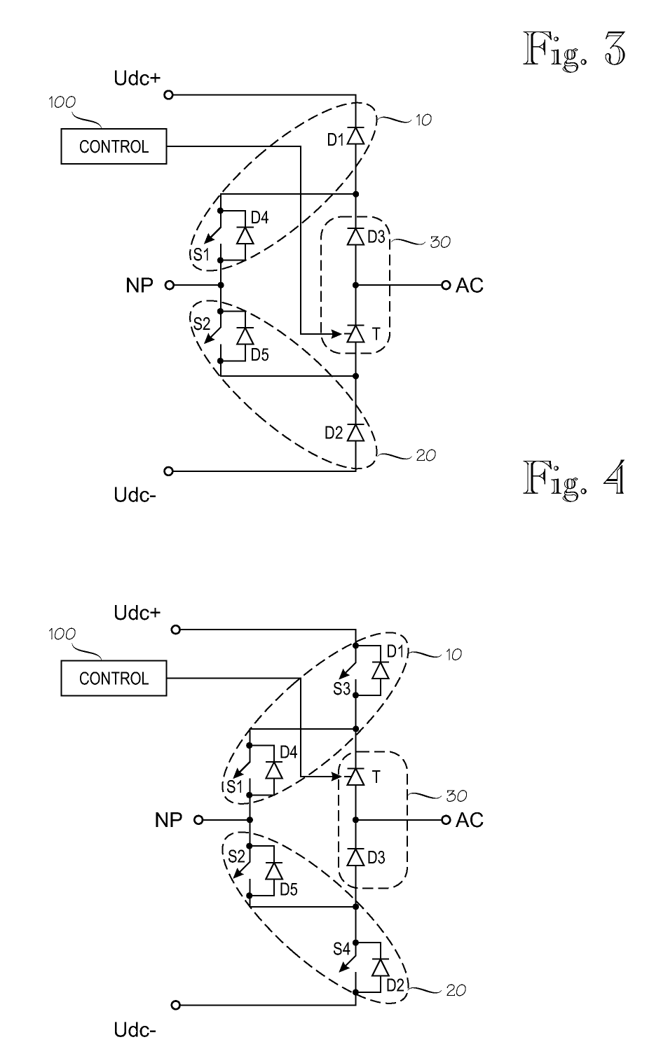

FIG. 3 shows a circuit diagram of a second switching branch for a rectifier according to an exemplary embodiment of the present disclosure. The exemplary switching branch shown in FIG. 3 corresponds to the example of the exemplary switching branch shown in FIG. 2 in all other respects but in the exemplary switching branch of FIG. 3 the thyristor T is connected between the connection point between the second diode D2 and the second semiconductor switch S2 and the alternating voltage pole AC of the switching branch, and the third diode D3 is connected between the connection point between the first diode D1 and the first semiconductor switch S1 and the alternating voltage pole AC of the switching branch.

According to an exemplary embodiment, the first diode D1 and the first semiconductor switch S1 of the switching branch reside in a first switching branch-specific semiconductor module 10, and the second diode D2 and the second semiconductor switch S2 of the switching branch reside in a second switching branch-specific semiconductor module 20. According to another exemplary embodiment, also a third diode of the switching branch and the thyristor can reside in a third switching branch-specific semiconductor module 30. Further, an exemplary embodiment disclosed herein, the fourth diode D4 of the switching branch resides in the first switching branch-specific semiconductor module, and the fifth diode D5 resides in the second switching branch-specific semiconductor module 20. In this context, the semiconductor module refers generally to a module that includes several semiconductor elements arranged on a common substrate and interconnected electrically in a suitable manner. By positioning the semiconductors in semiconductor modules in this manner it is possible to minimize stray inductance of a commutation circuit. The first semiconductor module 10 and the second semiconductor module 20 in the exemplary embodiment of FIG. 3 can be implemented by means of braking chopper modules. The third semiconductor module 30 may be implemented by means of a semi-controlled thyristor branch.

FIG. 4 shows a circuit diagram of a third switching branch for a rectifier according to an exemplary embodiment of the present disclosure. The exemplary embodiment of FIG. 4 also includes a third semiconductor switch S3, which is connected in parallel with the first diode D1, and a fourth semiconductor switch S4, which is connected in parallel with the second diode D2. The third semiconductor switch resides in the first semiconductor module 10, and the fourth semiconductor switch resides in the second semiconductor module 20. The first semiconductor module 10 and the second semiconductor module 20 in the example of FIG. 4 may be implemented by means of IGBT duals.

Initial charging of the capacitors C1, C2 in the rectifier intermediate circuit may be performed, for instance in the case of the exemplary switching branches of FIGS. 2 to 4, by means of phase angle control of the thyristor T. According to an exemplary embodiment of the present disclosure, control means, such as a control unit 100, of the thyristor T are arranged to change a thyristor control angle during the charging of the rectifier intermediate circuit in response to the voltage of the rectifier intermediate circuit and the supply voltage of the rectifier. Accordingly, the control angle of the thyristor T, i.e. the angle at which the thyristor is fired delayed from the earliest possible firing moment, is changed in response to the voltage of the rectifier intermediate circuit and the supply voltage of the rectifier so as to limit the charging current of the intermediate circuit. According to another exemplary embodiment, the control unit 100 is arranged to change a control angle of the thyristor T in response to the ratio or difference between the voltage value of the rectifier intermediate circuit and the supply voltage value of the rectifier. Initially, the control angle may be e.g. 180 degrees, i.e. the firing of the thyristor T is delayed 180 degrees from the earliest possible firing moment, and thereafter, as the intermediate circuit voltage rises, and consequently, as the ratio or difference between the intermediate circuit voltage value and the rectifier supply voltage value changes, the control angle of the thyristor T is reduced gradually. The intermediate circuit voltage having risen sufficiently high, the charging of the intermediate circuit may be ended and the thyristor T may be controlled to a diode mode, i.e. in practice, to a continuously conductive state, whereby it operates like a diode. Advantageously, the control unit 100 of the thyristor is arranged to control the thyristor T to the diode mode, when the intermediate circuit of the rectifier is not charged.

According to an exemplary embodiment of the present disclosure, the thyristor T may be controlled to a non-conductive state in response to a detected fault situation. The control unit 100 of the thyristor can be arranged to control the thyristor T to a non-conductive state in response to the detection of a fault state. Such a fault state may occur, for instance, in the switching branch of the rectifier, elsewhere in the rectifier or in a device connected to the rectifier, such as a device supplied by the rectifier, or in an alternating voltage feed that feeds the rectifier. An example of the fault situation is a fault in a rectifier component, or a short circuit or an earth fault in any one of the rectifier parts. A fault situation can be detected, for instance, by means of particular fault diagnostics functionality, which monitors the operation of the switching branch of the rectifier or that of the whole rectifier and detects if discrepancies from normal operation occur. Fault diagnostics functionality of this kind may be incorporated in the control unit 100 of the thyristor or implemented by one or more separate units (not shown).

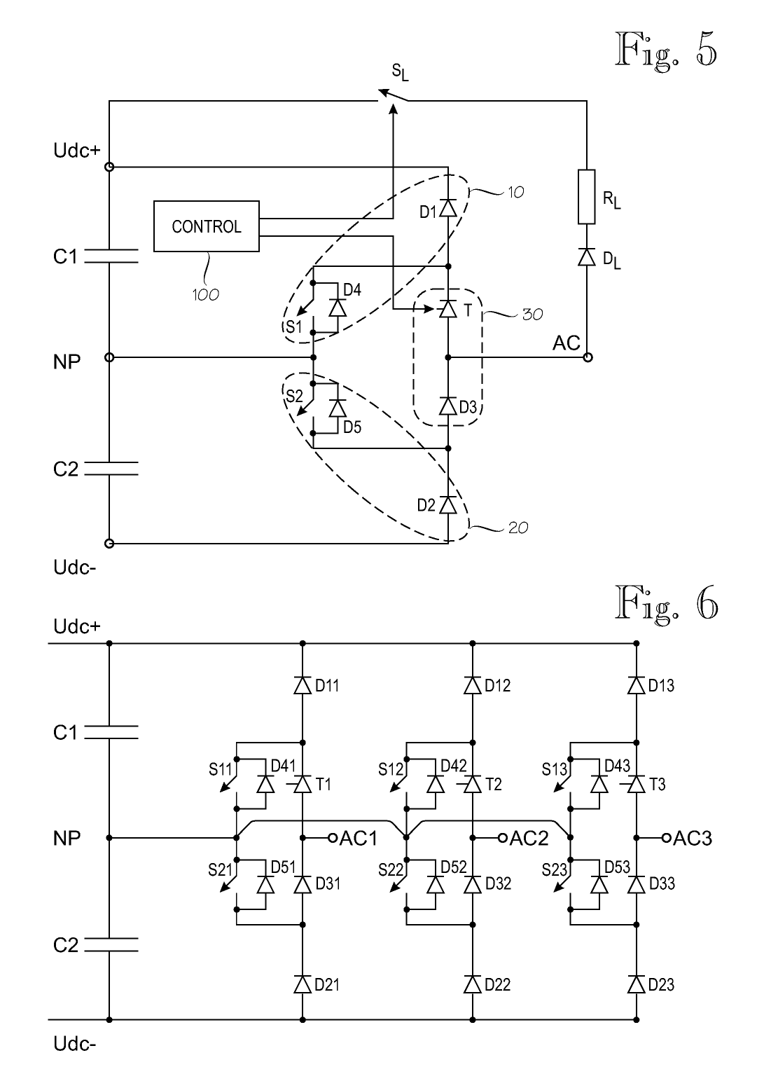

The initial charging of the capacitors C1, C2 of the rectifier intermediate circuit may also be carried out in another manner. FIG. 5 shows a circuit diagram of a fourth switching branch for a rectifier according to an exemplary embodiment of the present disclosure. The exemplary switching branch of FIG. 5 also includes charging means for charging the rectifier intermediate circuit. In accordance with the example of FIG. 5, the charging means may include e.g. a charging diode D_{L} and a charging resistor R_{L}, which are connected between the alternating voltage pole and the positive direct voltage pole of the switching branch, as well as a controllable switch S_{L}, such as a relay or a semiconductor switch. As shown in FIG. 5, the control unit 100 is arranged to control the switch S_{L} to be conductive and the thyristor T to a non-conductive state during the charging of the rectifier intermediate circuit. When the voltage in the intermediate circuit has risen sufficiently high and the charging of the intermediate circuit can be ended, the control unit 100 is arranged to control the switch S_{L} to a non-conductive state and the thyristor T to a continuously conductive state.

According to another exemplary embodiment of the present disclosure, the three-phase three-level converter may be implemented by interconnecting the three above-described switching branches of any one of the embodiments. FIG. 5 shows a circuit diagram of a fourth switching branch for a rectifier according to an exemplary embodiment of the present disclosure. The main circuit can be formed of three phase-specific switching branches as shown, for example in FIG. 2, which are interconnected by connecting the positive direct voltage pole Udc+, negative direct voltage pole Udc− and neutral direct voltage pole NP of each switching branch. Each switching branch correspondingly has alternating voltage input poles AC1, AC2, AC3 for connecting the rectifier to the three phases of the three-phase alternating voltage output (not shown). Each switching branch further includes a first diode D11, D12, D13 and a second diode D21, D22, D23, as well as a third diode D31, D32, D33 and a thyristor T1, T2, T3 that are connected in the manner shown above in connection with FIG. 2. In addition, each switching branch can include a first controllable semiconductor switch S11, S12, S13 and a second semiconductor switch S21, S22, S23 that are also connected in the manner shown above in connection with FIG. 2. The control components and couplings of the thyristors or semiconductor switches are not shown in the figure for the sake of clarity. Each exemplary switching branch of the rectifier of FIG. 6 may also include a fourth diode D41, D42, D43 and a fifth diode D51, D52, D53. As shown in FIG. 6, a direct voltage intermediate circuit of the rectifier can in turn, include capacitors C1 and C2 connected in series between the positive direct voltage pole Udc+ and negative direct voltage pole Udc− in such a manner that the neutral direct voltage pole NP is formed at the connecting point of the capacitors. The structure of the intermediate circuit may also include any other suitable component and circuit arrangement than that shown in FIG. 6.

The equipment, such as control unit 100, implementing the above-mentioned various functionalities and various combinations thereof, may be implemented by means of one or more units. The term “unit” refers generally to a physical or logic whole, such as a physical device, a part thereof or a software routine.

The equipment, such as the control unit 100, implementing the functionality of the various embodiments, can be implemented at least partly by means of a computer or the like signal processing equipment having appropriate software. An example of suitable signal processing equipment is a programmable logic controller (PLC). Such a computer or signal processing equipment advantageously includes at least a random access memory (RAM), which provides a storage area that arithmetic operations utilize, and a processor (CPU), such as a general-purpose digital signal processing processor (DSP), which performs the arithmetic operations. The processor may include a set of registers, an arithmetic logic unit and a processor control unit. The processor control unit is controlled with a program command sequence that is transferred to the processor from the random access memory. The processor control unit can include micro commands for basic operations. Implementation of the micro commands can vary depending on the structure of the processor. The program commands can be encoded in a programming language, which may be a high-level programming language, such as C, Java or the like, or a lower-level programming language, such as a machine language or an assembler. The computer can also include an operating system, which may provide system services for a computer program written with program commands. The computer or other equipment implementing the disclosed exemplary embodiments or a part thereof, such as control unit 100 or the like, may include suitable input means, for instance, for receiving control information or measuring information from the user and/or other devices, and output means, for instance, for outputting alarms and notices and/or control data as well as for controlling other devices. The equipment may additionally include a suitable user interface, through which the user may set specified parameters, for instance. It is also possible to use specific integrated circuits, such as ASICs (Application Specific Integrated Circuits) and/or discrete components or other devices so as to implement various embodiment functionalities in accordance with different embodiments.

The above-described different embodiments can be implemented in known systems, such as electric drives or components thereof, such as rectifiers or frequency converters, and/or it is possible to use separate elements and devices in a centralized or distributed manner. Existing devices for electric drives, such as rectifiers and frequency converters, can include a processor and memory that may be utilized in implementing the functionality of the different embodiments. Thus, all alterations and configurations specified to implement the different embodiments of the disclosure may be performed at least partly using software routines that in turn may be implemented as added or updated software routines. If the functionalities of the different embodiments are implemented by means of software, the software may be provided as a computer program product that comprises a computer program code, the execution of which on a computer makes the computer or corresponding hardware perform the functionality of the disclosure in accordance with the above-described different embodiments. This type of computer program code can be stored or generally incorporated in a computer-readable medium, such as a suitable storage medium, for instance a flash memory or optical memory, from which it may be read to a unit or units that execute the program code. In addition, this type of program code may be loaded onto a unit or units for execution over a suitable data network, and it may replace or update a possibly existing program code.

It will be apparent to a person skilled in the art that as technology advances, the exemplary embodiments of the present disclosure may be implemented in many different ways. The disclosure and its embodiments are thus not restricted to the examples described above but may vary within the scope of the claims.

It will be appreciated by those skilled in the art that the present invention can be embodied in other specific forms without departing from the spirit or essential characteristics thereof. The presently disclosed embodiments are therefore considered in all respects to be illustrative and not restricted. The scope of the invention is indicated by the appended claims rather than the foregoing description and all changes that come within the meaning and range and equivalence thereof are intended to be embraced therein.

What is claimed is:

1. A switching branch for a three-level rectifier, comprising:
a first diode and a first semiconductor switch connected in series between a positive direct voltage pole and a neutral direct voltage pole, wherein the first diode and the first semiconductor switch reside in a first switching branch-specific semiconductor module;
a second diode and a second semiconductor switch connected in series between a negative direct voltage pole and a neutral direct voltage pole, wherein the second diode and the second semiconductor switch reside in a second switching branch-specific semiconductor module; and
a thyristor and a third diode connected in series between a connection point between the first diode and the first semiconductor switch and a connection point between the second diode and the second semiconductor switch, wherein a connection point between the thyristor and the third diode is connected to an alternating voltage pole of the switching branch.

2. The switching branch for the rectifier of claim 1, wherein the thyristor is connected between the connection point between the first diode and the first semiconductor switch and the alternating voltage pole of the switching branch, and the third diode is connected between the connection point between the second diode and the second semiconductor switch and the alternating voltage pole of the switching branch.

3. The switching branch for the rectifier of claim 1, wherein the thyristor is connected between the connection point between the second diode and the second semiconductor switch and the alternating voltage pole of the switching branch, and the third diode is connected between the connection point between the first diode and the first semiconductor switch and the alternating voltage pole of the switching branch.

4. The switching branch for the rectifier of claim 1, wherein the thyristor and the third diode reside in a third switching branch-specific semiconductor module.

5. The switching branch for the rectifier of claim 1, further comprising:
a fourth diode connected in parallel with the first semiconductor switch; and
a fifth diode connected in parallel with the second semiconductor switch.

6. The switching branch for the rectifier of claim 5, wherein the fourth diode resides in the first switching branch-specific semiconductor module, and the fifth diode resides in the second switching branch-specific semiconductor module.

7. The switching branch for the rectifier of claim 1, further comprising:
a third semiconductor switch connected in parallel with the first diode; and
a fourth semiconductor switch connected in parallel with the second diode.

8. The switching branch for the rectifier of claim 7, wherein the third semiconductor switch resides in the first switching branch-specific semiconductor module, and the fourth semiconductor switch resides in the second switching branch-specific semiconductor module.

9. The switching branch for the rectifier of claim 1, further comprising:
control means arranged to change a control angle of the thyristor during the charging of the rectifier intermediate circuit in response to the voltage of the rectifier intermediate circuit and the supply voltage of the rectifier.

10. The switching branch for the rectifier of claim 9, wherein the control means are arranged to change the control angle of the thyristor in response to a ratio or difference of a voltage value of the rectifier intermediate circuit and a supply voltage value of the rectifier.

11. The switching branch for the rectifier of claim 1, further comprising:
charging means for charging the rectifier intermediate circuit; and
control means arranged to control the thyristor to a non-conductive state during the charging of the rectifier intermediate circuit.

12. The switching branch for the rectifier of claim 9, wherein the control means are arranged to control the thyristor to a diode mode, when the rectifier intermediate circuit is not charged.

13. The switching branch for the rectifier of claim 9, wherein the control means are arranged to control the thyristor to a non-conductive state in response to a detected fault state.

14. A three-phase three-level rectifier, comprising three switching branches according to claim 1.

15. The rectifier of claim 14, wherein the positive direct voltage poles of each switching branch are interconnected, and the negative direct voltage poles of each switching branch are interconnected and the neutral direct voltage poles of each switching branch are interconnected.

16. A method of charging an intermediate circuit in a rectifier including a first diode and a first semiconductor switch connected in series between a positive direct voltage pole and a neutral direct voltage pole, wherein the first diode and the first semiconductor switch reside in a first switching branch-specific semiconductor module; a second diode and a second semiconductor switch connected in series between a negative direct voltage pole and a neutral direct voltage pole, wherein the second diode and the second semiconductor switch reside in a second switching branch-specific semiconductor module; and a thyristor and a third diode connected in series between a connection point between the first diode and the first semiconductor switch and a connection point between the second diode and the second semiconductor switch, wherein a connection point between the thyristor and the third diode is connected to an alternating voltage pole of the switching branch, the method comprising:
detecting a voltage of the rectifier;
detecting a supply voltage of the rectifier; and
adjusting a control angle of the thyristor in response to the voltage of the rectifier and the supply voltage of the rectifier.

17. A computer readable medium for an electric drive having a processor, memory, a first diode and a first semiconductor switch connected in series between a positive direct voltage pole and a neutral direct voltage pole, wherein the first diode and the first semiconductor switch reside in a first switching branch-specific semiconductor module; a second diode and a second semiconductor switch connected in series between a negative direct voltage pole and a neutral direct voltage pole, wherein the second diode and the second semiconductor switch reside in a second switching branch-specific semiconductor module; and a thyristor and a third diode connected in series between a connection point between the first diode and the first semiconductor switch and a connection point between the second diode and the second semiconductor switch, wherein a connection point between the thyristor and the third diode is connected to an alternating voltage pole of the switching branch,
the computer readable medium having computer program product recorded thereon which when the computer readable medium is placed in communicable contact with the electric drive, the electric drive executes a method comprising the steps of:
detecting a voltage of the rectifier;
detecting a supply voltage of the rectifier; and
adjusting a control angle of the thyristor in response to the voltage of the rectifier and the supply voltage of the rectifier.

18. The computer readable medium of claim 17, wherein the control angle of the thyristor is adjusted based on a ratio of the intermediate voltage of the rectifier and the supply voltage of the rectifier.

19. The computer readable medium of claim 17, wherein the thyristor is controlled to a continuously conductive state where it operates as a diode.
